(19) United States
(12) Patent Application Publication
(10) Pub. No.: US 2009/0120862 A1
(43) Pub. Date: May 14, 2009

(54) Method of ecological restoration of water bodies containing excess nutrient

(75) Inventors: Zhigang Lv, Beijing (CN); Ming Ji, Beijing (CN)

Correspondence Address: ZHEN ZHENG LU, 1730 HUNTINGTON DRIVE #304, DUARTE, CA, 91010, US

(73) Assignee: Xu, Xiaohua

(21) Appl. No.: 12/122,725

(22) Filed: May 19, 2008

(30) Foreign Application Priority Data
Nov. 13, 2007 (CN) 200710177266.3

(51) Int. Cl. C02F 9/08; C02F 1/00

(52) U.S. Cl. 210/170.11

(57) ABSTRACT

A sea water desalinating system with jetting cavitational technology includes a sea water collecting device for collecting sea-water, a water transmitting pump communicated with the collecting device, a coarse filtering device communicated with the water transmitting pump for filtering impurities, a fine filtering device communicated with the coarse filtering device for further filtering, a booster pump communicated with the fine filtering device for further transmission, at least one jetting cavitational device communicated with the booster pump for sterilizing, flocculating, and preventing scale, a sea water desalination device communicated with the jetting cavitational device for desalinating the sea water, and a fresh water storing device communicated with the sea water desalination device for storing fresh water got from the system.

### BACKGROUND OF THE PRESENT INVENTION

1. Field of Invention

The present invention relates to a sea-water desalinating system, and more particularly to a sea-water desalinating system adopting jetting cavitational technology, belongs to C02F1/00 according to the international classification of patent.

2. Description of Related Arts

At present, there are a lot of means in domestic and overseas, such as Rheological Phase, Evaporation, Distillation, Cooling, Membrane Separation, Counter-infiltration, Electrodialysis, Chemistry Equilibrium, Lon Exchange, Hydration, Solvent Extraction, and so on. The Flash Distillation and the Reverse Osmosis Membrane means are widely used currently. The sea-water desalinating production produced by the above two means is 90% of the gross production. The drawbacks of the present means are: large investment, high power consumption, low production rate, high cost, medical additive requirement, and low quality.

### SUMMARY OF THE PRESENT INVENTION

A main object of the present invention is to provide a sea-water desalinating system adopting jetting cavitational technology.

Accordingly, in order to accomplish the above object, the present invention provides a sea water desalinating system with jetting cavitational technology which comprises a sea water collecting device for collecting sea-water, a water transmitting pump communicated with the collecting device, a coarse filtering device communicated with the water transmitting pump for filtering impurities, a fine filtering device communicated with the coarse filtering device for further filtering, a booster pump communicated with the fine filtering device for further transmission, at least one jetting cavitational device communicated with the booster pump for sterilizing, flocculating, and preventing scale, a sea water desalination device communicated with the jetting cavitational device for desalinating the sea water, and a fresh water storing device communicated with the sea water desalination device for storing fresh water got from the system.

The advantages are illustrated as follows:

(1) The fresh water that is got from the sea water processed via jetting caviational technology contains many kinds of trace elements and minerals, which is benefit to the human body, and has each performance higher than the standard for drinking water quality in china; while the fresh water that is got from conventional processing means contains a lot of chemical additives added in the preliminary processing and the output stage, which is bad in quality, and does not suitable for drinking.

(2) The present invention is simple in structure, less equipment investment, low cost, stable in performance. Comparing to the present sea water desalinating system, the present invention reduces or eliminates the medical additive step in the preliminary processing for sterilizing, flocculating, and preventing scale. The microorganisms in the sea water are sterilized in the acoustic field and flocculated forming a cluster of small molecules in the jetting caviational processing, so that the fresh water can be easier for humane body to absorb. Using the cluster of small molecules to make fresh water can prolongs the life span of the reverse osmosis membrane, prevents the scale of the distilling equipment, and prolong the preservation period of the fresh water.

(3) The equipment of the present invention can support other equipment. It can be configured at a front end of the conventional sea water desalinating equipment, and can optimize, upgrade, and reform the conventional sea water desalinating system.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a sea water desalination system with jetting cavitational technology according to a preferred embodiment of the present invention.

FIG. 2 is a schematic view of an alternative mode of the sea water desalination system with jetting cavitational technology according to the above preferred embodiment of the present invention.

FIG. 3 is a schematic view of a second alternative mode of the sea water desalination system with jetting cavitational technology according to the above preferred embodiment of the present invention.

FIG. 4 is a schematic view of a third alternative mode of the sea water desalination system with jetting cavitational technology according to the above preferred embodiment of the present invention.

FIG. 5 is a schematic view of a jetting cavitational device of the sea water desalination system with jetting cavitational technology according to the above preferred embodiment of the present invention.

FIG. 6 is a sectional view of a jetting cavitational device of the sea water desalination system with jetting cavitational technology according to the above preferred embodiment of the present invention.

### DETAILED DESCRIPTION OF THE PREFERRED EMBODIMENT

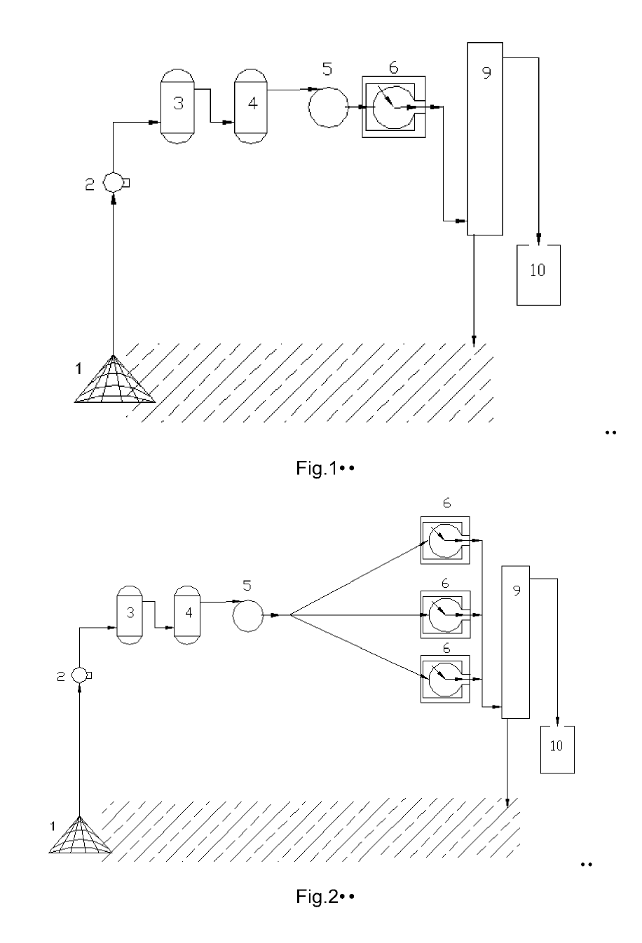

Referring to FIG. 1 of the drawings, a sea-water desalinating system adopting jetting cavitational technology according to a preferred embodiment of the present invention is illustrated.

The sea-water desalinating system adopting jetting cavitational technology comprises a coarse filtering device 3, a fine filtering device 4, a sea water collecting device 1 for collecting sea-water, a water transmitting pump 2 communicated with the collecting device 1 for transmitting the sea-water, a coarse filtering device 3 for filtering impurities, a fine filtering device 4 for further filtering, a booster pump 5 communicated with said fine filtering device for further transmission, a jetting cavitational device 6 communicated with said booster pump for sterilizing, flocculating, and preventing scale, a sea water desalination device 9 communicated with said jetting cavitational device for desalinating the sea water, and a fresh water storing device 10 communicated with the sea water desalination device.

The sea water to be desalination is collected by the sea water collecting device 1, and transmitted to the coarse filtering device 3 by the water transmitting pump 2 to be pre-filtered for eliminating various kinds of impurities. Then the sea water enters into the fine filtering device 4 for being further filtered, and is transmitted to the jetting cavitational device 6 by the booster pump 5. The jetting cavitational device 6 sterilizes and flocculates the sea water, and gets purified sea water. Then the purified sea water is transmitted into the sea water desalination device 9 to be desalinated and becomes fresh water. The fresh water is stored in a fresh water storing device 10. As shown in FIG. 2 and FIG. 3, the jetting cavitational device 6 can be cascaded in series or in parallel to improve the quality of the water processing system or the efficiency of water processing system.

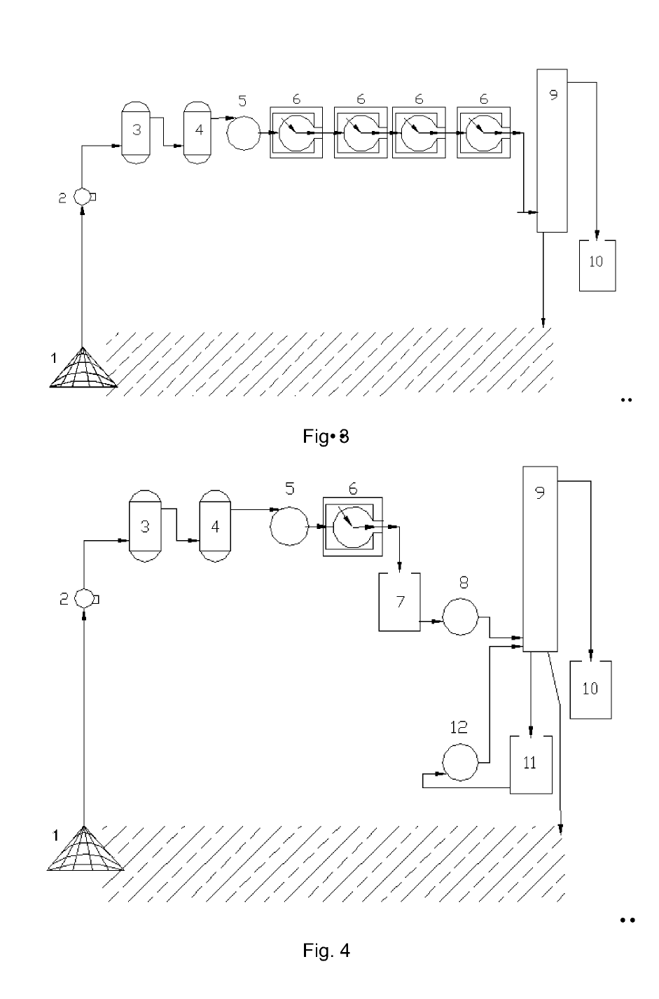

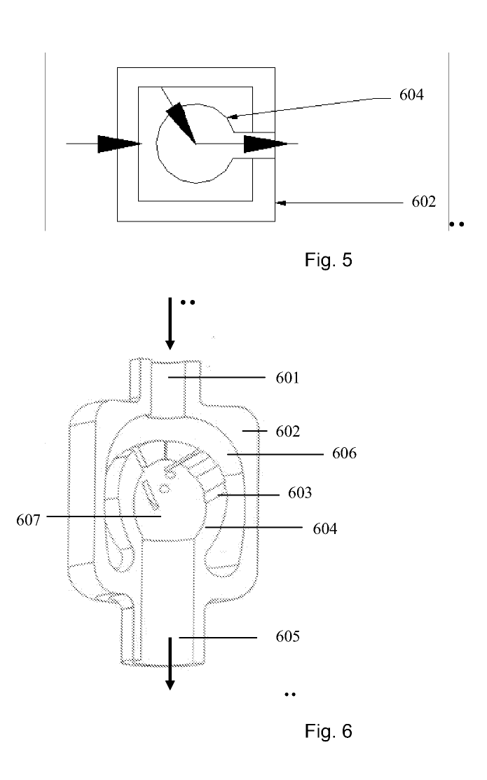

Referring to FIG. 4 of the drawings, the sea water desalination system further comprises a sea water storing device 7, and a second water transmitting pump 8 between the jetting cavitational device and the sea water desalination device, wherein the sea water storing device is communicated with the jetting cavitational device, and the second water transmitting pump is communicated with the sea water desalination device. The sea water to be desalination is collected by the sea water collecting device 1, and transmitted to the coarse filtering device 3 by the water transmitting pump 2 to be pre-filtered for eliminating various kinds of impurities. Then the sea water enters into the fine filtering device 4 for being further filtered, and is transmitted to the jetting cavitational device 6 by the booster pump 5. The jetting cavitational device 6 sterilizes and flocculates the sea water, and gets purified sea water. Then the purified sea water is stored in a sea water storing device 7, and transmitted to the sea water desalination device 9 to be desalinated and becomes fresh water. The fresh water is stored in a water storing device 10. The sea water desalination device 9 can be a reverse osmosis membrane filtering device or a distilling device. If the sea water desalination device 9 adopts a reverse osmosis membrane filtering device, the sea water desalination system may further comprises a circulating subsystem comprising a concentrated water storing device 11 and a third water transmitting pump 12 communicated with the concentrated water storing device 11, wherein the sea water desalination device 9 outputs to the concentrated water storing device 11, then to the third water transmitting pump 12, and back to the sea water desalination device 9, as shown in FIG. 4.

The pressure of booster pump 5 is 0.2 Mpa to 80 Mpa, and the power of the booster pump 5 is 2 KW to 500 KW.

The jetting cavitational device 6 comprises an outer sealed casing 602 having an inlet 601, an inner casing 604 that can be of any shape, such as circular, column, elliptical, cubic, and so on, having a inner cavitational cavity 607 provided therein, wherein the outer sealed casing and the inner casing forms a annular cavity 606 therebetween, which communicates with the inlet 601 of the outer sealed casing. The inner casing 604 is connected with the outer sealed casing forming an outlet path 605 for communicating the inner cavitational cavity 607 and the outside of the outer sealed casing 602. In addition, the inner casing 604 has a plurality of ejector nozzles 603 thereon for communicating the inner cavitational cavity 607 and the annular cavity 606 between the outer sealed casing 602 and the inner casing 604. The ejector nozzle 603 can be of any size, number, shape, location according to the requirement of the material to be processed. The ratio of the cross sectional area of the ejector nozzle 603 to the cross sectional area of the inlet of the outer sealed casing 602 is 1 to 100:500, and to the cross sectional area of the outlet path 605 is 1 to 100:1000.

The cavitational mentioned in the present invention is a physical phenomenon. Cavitational means that cavities or bubbles are forming in the liquid that we're pumping. These cavities form at the low pressure or suction side of the pump. The cavities or bubbles will collapse when they pass into the higher regions of pressure, causing shock wave, large pressure in every tiny area.

The jetting cavitational technology utilized in the present invention is a liquid acoustic energy technology, which can produce cavitational vibration via acoustic wave transmitting in a liquid. Therefore, if the area and range of cavitational vibration is effectively controlled, the material to be processed will be made a chemical or physical reaction.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sea water desalinating system with jetting cavitational technology, comprising a sea water collecting device for collecting sea-water, a water transmitting pump communicated with said collecting device, a coarse filtering device communicated with said water transmitting pump for filtering impurities, a fine filtering device communicated with said coarse filtering device for further filtering, a booster pump communicated with said fine filtering device for further transmission, at least one jetting cavitational device communicated with said booster pump for sterilizing, flocculating, and preventing scale, a sea water desalination device communicated with said jetting cavitational device for desalinating the sea water, and a fresh water storing device communicated with said sea water desalination device for storing fresh water got from the system.

2. The sea water desalinating system, as recited in claim 1, further comprising two or more jetting cavitational devices that are cascaded in series.

3. The sea water desalinating system, as recited in claim 1, further comprising two or more jetting cavitational devices that are cascaded in parallel.

4. The sea water desalinating system, as recited in claim 1, wherein said jetting cavitational device comprises an outer sealed casing having an inlet, and an inner casing having a inner cavitational cavity provided therein, wherein said outer sealed casing and said inner casing forms a annular cavity therebetween communicating with said inlet of said outer sealed casing, wherein said inner casing is connected with said outer sealed casing forming an outlet path for communicating said inner cavitational cavity with outside of said outer sealed casing, wherein said inner casing has a plurality of ejector nozzles thereon for communicating said inner cavitational cavity and said annular cavity.

5. The sea water desalinating system, as recited in claim 2, wherein said jetting cavitational device comprises an outer sealed casing having an inlet, and an inner casing having a inner cavitational cavity provided therein, wherein said outer sealed casing and said inner casing forms a annular cavity therebetween communicating with said inlet of said outer sealed casing, wherein said inner casing is connected with said outer sealed casing forming an outlet path for communicating said inner cavitational cavity with outside of said outer sealed casing, wherein said inner casing has a plurality of ejector nozzles thereon for communicating said inner cavitational cavity and said annular cavity.

6. The sea water desalinating system, as recited in claim 3, wherein said jetting cavitational device comprises an outer sealed casing having an inlet, and an inner casing having a inner cavitational cavity provided therein, wherein said outer sealed casing and said inner casing forms a annular cavity therebetween communicating with said inlet of said outer sealed casing, wherein said inner casing is connected with said outer sealed casing forming an outlet path for communicating said inner cavitational cavity with outside of said outer sealed casing, wherein said inner casing has a plurality of ejector nozzles thereon for communicating said inner cavitational cavity and said annular cavity.

7. The sea water desalinating system, as recited in claim 4, wherein said sea water desalination device is a reverse osmosis membrane filtering device.

8. The sea water desalinating system, as recited in claim 5, wherein said sea water desalination device is a reverse osmosis membrane filtering device.

9. The sea water desalinating system, as recited in claim 6, wherein said sea water desalination device is a reverse osmosis membrane filtering device.

10. The sea water desalinating system, as recited in claim 7, further comprising a circulating subsystem comprising a concentrated water storing device and a third water transmitting pump communicated with said concentrated water storing device, wherein said sea water desalination device outputs to said concentrated water storing device, then to said third water transmitting pump, and back to said sea water desalination device.

11. The sea water desalinating system, as recited in claim 8, further comprising a circulating subsystem comprising a concentrated water storing device and a third water transmitting pump communicated with said concentrated water storing device, wherein said sea water desalination device outputs to said concentrated water storing device, then to said third water transmitting pump, and back to said sea water desalination device.

12. The sea water desalinating system, as recited in claim 9, further comprising a circulating subsystem comprising a concentrated water storing device and a third water transmitting pump communicated with said concentrated water storing device, wherein said sea water desalination device outputs to said concentrated water storing device, then to said third water transmitting pump, and back to said sea water desalination device.

13. The sea water desalinating system, as recited in claim 4, wherein said sea water desalination device is a distilling device.

14. The sea water desalinating system, as recited in claim 1, further comprising a sea water storing device and a second water transmitting pump communicated with said sea water storing device between said jetting cavitational device and said sea water desalination device, wherein said sea water storing device is communicated with said jetting cavitational device, and said second water transmitting pump is communicated with said sea water desalination device.

15. The sea water desalinating system, as recited in claim 4, further comprising a sea water storing device and a second water transmitting pump communicated with said sea water storing device between said jetting cavitational device and said sea water desalination device, wherein said sea water storing device is communicated with said jetting cavitational device, and said second water transmitting pump is communicated with said sea water desalination device.

16. The sea water desalinating system, as recited in claim 5, further comprising a sea water storing device and a second water transmitting pump communicated with said sea water storing device between said jetting cavitational device and said sea water desalination device, wherein said sea water storing device is communicated with said jetting cavitational device, and said second water transmitting pump is communicated with said sea water desalination device.

17. The sea water desalinating system, as recited in claim 6, further comprising a sea water storing device and a second water transmitting pump communicated with said sea water storing device between said jetting cavitational device and said sea water desalination device, wherein said sea water storing device is communicated with said jetting cavitational device, and said second water transmitting pump is communicated with said sea water desalination device.

18. The sea water desalinating system, as recited in claim 4, wherein said booster pump has a pressure from 0.2 Mpa to 80 Mpa, and has a power from 2 KW to 500 KW.

19. The sea water desalinating system, as recited in claim 10, wherein said booster pump has a pressure from 0.2 Mpa to 80 Mpa, and has a power from 2 KW to 500 KW.

20. The sea water desalinating system, as recited in claim 4, wherein said a ratio of a cross sectional area of the ejector nozzle to a cross sectional area of said inlet of said outer sealed casing is 1 to 100:500, and to a cross sectional area of said outlet path is 1 to 100:1000.
